(19) United States
(12) Patent Application Publication
(10) Pub. No.: US 2014/0188894 A1
(43) Pub. Date: Jul. 3, 2014

(54) TOUCH TO SEARCH

(71) Applicant: Google Inc., (US)

(72) Inventors: Gal Chechik, Los Altos, CA (US); Asaf Zomet, Jerusalem (IL); Michael Shynar, Tel Aviv (IL)

(73) Assignee: Google Inc., Mountain View, CA (US)

(21) Appl. No.: 13/728,419

(22) Filed: Dec. 27, 2012

(51) Int. Cl. G06F 17/30

(52) U.S. Cl. CPC G06F 17/30424
USPC 707/748

(57) ABSTRACT

Methods, systems, and apparatus, including computer programs encoded on a computer storage medium, for identifying a query for selected content. In one aspect, a method includes receiving gesture data specifying a user gesture interacting with a portion of displayed content. A subset of the content is identified based on the gesture data. A set of candidate search queries is identified based on the subset of the content. A likelihood score is determined for each candidate search query. The likelihood score for a candidate search query indicates a likelihood that the candidate search query is an intended search query specified by the user gesture. The likelihood score for each candidate search query is adjusted using a normalization factor. The normalization factor can be based on a number of characters included in the candidate search query. One or more of the candidate search queries are selected based on the adjusted likelihood scores.

### BACKGROUND

This specification relates to information retrieval.

The Internet provides access to a wide variety of resources, such as image files, audio files, video files, and web pages. A search system can identify resources in response to queries. The queries can be text queries that include one or more search terms or phrases, image queries that include images, or a combination of text and image queries. The search system ranks the resources and provides search results that may link to the identified resources or provide content relevant to the queries. The search results are typically ordered for viewing according to the rank.

Some techniques for entering a search query on a user device, such as a smartphone, require a user to type search terms using either a keyboard or a touchscreen interface. The search terms are typically displayed in a text-based search box as they are entered by the user. The search terms entered by the user are then transmitted to search system, for example in response to the user selecting a “submit” button.

### SUMMARY

In general, one innovative aspect of the subject matter described in this specification can be embodied in methods that include the actions of receiving gesture data specifying a user gesture interacting with a portion of displayed content; identifying a subset of the content based on the gesture data; identifying a set of candidate search queries based at least on the subset of the content; for each candidate search query: determining a likelihood score for the candidate search query, the likelihood score for the candidate search query indicating a likelihood that the candidate search query is an intended search query specified by the user gesture; and adjusting the likelihood score for the candidate search query using a normalization factor, the normalization factor being based on a number of characters included in the candidate search query; and selecting one or more of the candidate search queries based on the adjusted likelihood scores. Other embodiments of this aspect include corresponding systems, apparatus, and computer programs, configured to perform the actions of the methods, encoded on computer storage devices.

These and other embodiments can each optionally include one or more of the following features. Aspects can further include identifying search results responsive to the one or more selected candidate search queries and providing the identified search results.

The likelihood score for a candidate search query can be based on a number of occurrences of the candidate search query in one or more documents. The likelihood score for a candidate search query can be based on a number of occurrences of the candidate search query in a set of received search queries.

The normalization factor can be based on a number of search queries in a set of received search queries that include the number of characters included in the candidate search query. The normalization factor can be further based on a number of words included in the candidate search query. Adjusting the likelihood score for a candidate search query using a normalization factor can include determining a ratio between the likelihood score for the candidate search query and the normalization factor for the candidate search query.

Aspects can further include identifying a semantic signal for a particular candidate search query. The sematic signal can indicate that the particular candidate search query has a particular semantic meaning Aspects can further include improving the adjusted likelihood score in response to identifying the semantic signal.

Aspects can further include determining that a particular candidate search query matches a meta information label associated with a document containing the displayed content and in response to determining that the particular candidate search query matches a meta information label associated with a document containing the displayed content, further adjusting the adjusted likelihood score for the particular candidate search query.

A particular candidate search query can have a number of words (“n”) and a number of characters (“x”). Adjusting the likelihood score for the particular candidate search query using a normalization factor, the normalization factor being based on a number of characters included in the particular candidate search query, can include identifying a likelihood of receiving a search query that has “n” words and “x” characters as the normalization factor for the particular candidate search query; and dividing the likelihood score for the particular candidate search query by the normalization factor for the particular search query to determine the adjusted likelihood score for the particular candidate search query.

Particular embodiments of the subject matter described in this specification can be implemented so as to realize one or more of the following advantages. User can initiate search queries by selecting content displayed on a touchscreen using a gesture rather than typing the search query into a search interface. Candidate search queries can be identified based on the content selected by way of the gesture and used for a search operation to identify search results that are relevant to the selected content. These candidate search queries are scored based on the likelihood that the queries are the query intended by the user to enable the most relevant search results to be provided. The scores for the queries can be normalized based on their lengths to remove biases associated with users' preference for entering short queries.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a search system provides search services.

FIG. 2 is a flow chart of an example process for submitting a search query and presenting search results responsive to the search query.

FIG. 3 is a flow chart of an example process for providing search results in response to a search query.

FIG. 4 is a flow chart of an example process for determining likelihood scores for candidate search queries.

FIG. 5 is a flow chart of an example process for selectively adjusting a likelihood score for a candidate search query.

FIG. 6 is a flow chart of an example process for adjusting a likelihood score for a candidate search query.

Like reference numbers and designations in the various drawings indicate like elements.

### DETAILED DESCRIPTION

### Overview

A system can provide search results in response to search requests initiated by way of gestures, such as interactions with a touchscreen. For example, rather than entering a search query into a search box, a user may sweep a finger around content displayed on a web page to initiate a search based on the content. Other gestures, such as a long touch at a particular location on the touchscreen, moving a device in a particular way, making a particular signal to a camera, can also initiate a search based on content selected by the gesture.

As the content selected using a gesture may be somewhat incomplete or ambiguous, the system can identify and rank candidate search queries based on the content selected by way of the gesture, and optionally unselected content that is presented near the selected content. Additional candidate search queries can also be generated by refining one or more of the set of candidate search queries.

In some implementations, a likelihood score is determined for each candidate search query. The likelihood score indicates the likelihood that the candidate search query is the query intended by the user. In some implementations, the likelihood score for a candidate search query is based on the number of times the candidate search query has been received by the system, or a probability that the system will receive the candidate search query. In some implementations, the likelihood score for a candidate search query is based on the number of times the candidate search query appears in the document displaying the content or in a corpus of documents.

Each of the likelihood scores for the candidate search queries can be adjusted based on a respective normalization factor. The normalization factor can account for users' preferences for entering short queries rather than long queries. For example, shorter queries may be received more frequently than longer queries, although the longer queries may be a better query for the information that the user is attempting to find. In some implementations, the normalization factor for a candidate search query is based on the length of the query, for example, the number of characters included in the query and/or the number of terms in the query. The normalization factor for a query of a particular length can be determined based on the popularity of queries having that particular length.

The likelihood score for each candidate search query can be adjusted by dividing the likelihood score by the respective normalization factor. In such an implementation, the normalization factor for longer queries may be less than the normalization factor for shorter queries.

The candidate search queries can be ranked based on the adjusted likelihood scores and one or more of the higher ranked candidate search queries can be selected. The selected candidate search queries can be provided to a search engine. In response, the search engine can provide search results responsive to the candidate search queries for presentation on the user device.

### Example Operating Environment

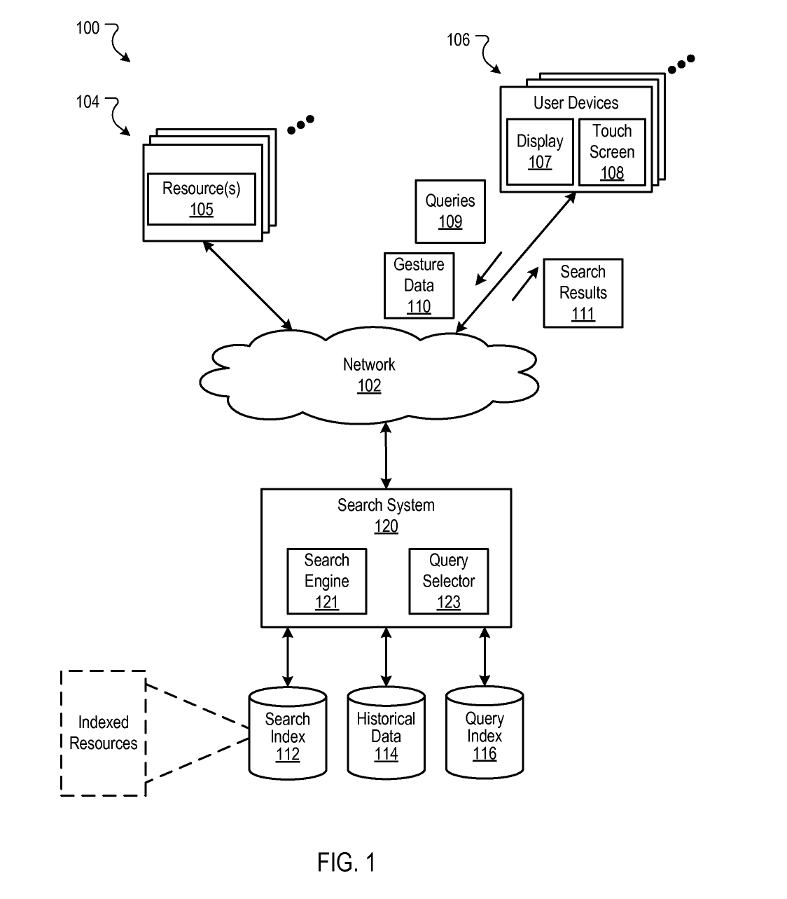

FIG. 1 is a block diagram of an example environment 100 in which a search system 120 provides search services. A computer network 102, such as a local area network (LAN), wide area network (WAN), the Internet, a mobile phone network, or a combination thereof, connects web sites 104, user devices 106, and the search system 120. The environment 100 may include many thousands of web sites 104 and user devices 106.

A web site 104 is one or more resources 105 associated with a domain name and hosted by one or more servers. An example web site 104 is a collection of web pages formatted in hypertext markup language (HTML) that can contain text, images, multimedia content, and programming elements, such as scripts. Each web site 104 is maintained by a publisher, e.g., an entity that manages and/or owns the web site.

A resource 105 is any data that can be provided by a web site 104 over the network 102 and that is associated with a resource address. Resources 105 include HTML pages, word processing documents, portable format (PDF) documents, images, video, and feed sources, to name just a few. The resources 105 can include content, such as words, phrases, images, and sound, and may include embedded information, e.g., meta information and hyperlinks, and/or embedded instructions, e.g., scripts.

A user device 106 is an electronic device that is capable of requesting and receiving resources 105 over the network 102. Example user devices 106 include personal computers, mobile communication devices, and other devices that can send and receive data over the network 102. A user device 106 typically includes a user application, such as a web browser, to facilitate the sending and receiving of data over the network 102.

The user device 106 includes a display 107 and a touchscreen 108. The display 107 may include a liquid crystal display, light emitting diode display, plasma display, or another suitable type of display capable of displaying content. The touchscreen 108 may include a sensor capable of sensing pressure input, capacitance input, resistance input, piezoelectric input, optical input, acoustic input, another suitable input, or a combination thereof. The touchscreen may be capable of receiving touch-based gestures. For example, received gestures may be interpreted to generate data relating to one or more locations on the surface of the touchscreen 108, pressure of the gesture, speed of the gesture, duration of the gesture, direction of paths traced on its surface by the gesture, motion of the user device 106 in relation to the gesture, and/or other suitable data regarding a gesture.

In some implementations, the user device 106 includes an accelerometer that is capable of receiving information about the motion characteristics, acceleration characteristics, orientation characteristics, or inclination characteristics of the user device 106. The user device 106 may be configured to interpret certain motions, as detected by the accelerometer, as gestures for selecting content presented on the display 107. For example, the user device 106 may interpret shaking of the user device 106 in a side to side motion as a gesture to select content presently displayed on the display 107.

The user device 106 may also include a camera that is capable of capturing images and/or video. Certain images or video may be interpreted by the user device 106 as a gesture for selecting content. A camera may be used to capture video of a user selecting content displayed on a display screen, or a static medium, such as a book or magazine. For example, the user device 106 may monitor the movement of a user's finger or pointing device as it moves about content, for example to circle or enclose content. Where the content is displayed on an electronic device, such as the user device 106, or another device in data communication with the camera, the electronic device 106 can display an indicator, such as a line, that shows the path of the user's finger or pointer. This enables the user to control the movement of the line in a similar was as the user would control it on a touchscreen. For example, if the user circled several displayed words, a line or other indicator may be displayed about the words to indicate to the user what has been selected. As capturing gesture data using a camera may be more noisy than other gesture capturing mechanisms, the query scoring processes described herein can be very beneficial to users attempting to initiate a search related to displayed content.

The user device 106 can submit search requests to the search system 120 in multiple ways. For example, the user device 106 may submit a search query 109 to the search system 120 in response to a user entering the search query 109 into a search box of a search interface. The user device 106 can also send gesture data 110 that includes data identifying content selected by way of a gesture at the touchscreen 108. For example, the user device 106 may be configured to send the gesture data 110, along with a request for search results 111, in response to detecting particular gestures. These gestures may include a long-touch or the circling of content, as described in more detail below.

The search system 120 includes a search engine 121 and a query selector 123. The search engine 121 identifies resources 105 responsive to search requests received from user devices 106. For search requests that include gesture data 110, the query selector 123 identifies one or more search queries based on the content specified by the gesture data 110 and provides the search queries to the search engine 121 to identify resources responsive to the search queries. The search engine 121 generates search results 111 that identify the resources 105 and provides the search results 111 to the user device 106 from which the search request was received.

In some implementations, the query selector 123 may be a part of the user devices 106 rather than, or in addition to, the search system 120. A user device 106 having the query selector 123 may detect a gesture, identify content specified by the gesture, and identify one or more search queries based on the content specified by the gesture. The user device 106 can send the one or more search queries, along with a search request, to the search engine 121. In turn, the search engine 121 can identify resources responsive to the one or more search queries, generate search results 111 that identify the resources, and provide the search results 111 to the user device 106 from which the search request was received.

In some implementations, the query selector 123 may be a part of a third party system. In such an implementation, the user device 106 may send the gesture data 110 to the third party system, for example by way of the network 102. In response to receiving the gesture data 110, the third party system may identify one or more search queries based on the content specified by the gesture, as identified by the gesture data, and provide the one or more search queries to the search engine 121. In turn, the search engine 121 can identify resources responsive to the one or more search queries, generate search results 111 that identify the resources, and provide the search results 111 to the user device.

To facilitate searching of resources 105, the search engine 121 identifies the resources 105 by crawling and indexing the resources 105 provided on web sites 104. Data about the resources 105 can be indexed based on the resource 105 to which the data corresponds. The indexed and, optionally, cached copies of the resources 105 are stored in a search index 112.

When the search engine 123 receives a search query, for example from a user device 106 or the query selector 123, the search engine 121 performs a search operation that uses the search query 109 as input to identify resources 105 responsive to the search query 109. For example, the search engine 121 may access the search index 112 to identify resources 105 that are relevant to the search query 109. The search engine 121 identifies the resources 105, generates search results 111 that identify the resources 105, and returns the search results 111 to the user devices 106.

The search query 109 can include one or more search terms. A search term can, for example, include a keyword submitted as part of a search query 109 to the search system 120 that is used to retrieve responsive search results 111. In some implementations, a search query 109 can include data for a single query type or for two or more query types, e.g., types of data in the query. For example, the search query 109 may have a text portion, and the search query 109 may also have an image portion. A search query 109 that includes data for two or more query types can be referred to as a “hybrid query.” In some implementations, a search query 109 includes data for only one type of query. For example, the search query 109 may only include image query data, e.g., a query image, or the search query 109 may only include textual query data, e.g., a text query.

A search result 111 is data generated by the search engine 121 that may identify a resource 105 that is responsive to a particular search query 109, and includes a link to the resource 105. An example search result 111 can include a web page title, a snippet of text or an image or portion thereof extracted from the web page, and a hypertext link, e.g., a uniform resource locator (URL), to the web page. Another example search result 111 can provide content relevant to the search query 109, but may not identify or link to a resource 105.

The search terms in the search query 109 can control the resources identified by the search engine 121, and thus the search results 111 that are generated by the search engine 121. Although the actual ranking of the search results 111 varies based on the ranking process used by the search engine 121, the search engine 121 can generate and rank search results 111 based on the search terms submitted through a search query 109.

The user devices 106 receive the search results pages and render the pages for presentation to the users. In response to the user selecting a search result 111 at a user device 106, the user device 106 requests the resource identified by the resource locator included in the search result 111. The web site 104 hosting the resource 105 receives the request for the resource 105 from the user device 106 and provides the resource 105 to the requesting user device 106.

Data for the search queries 109 submitted during user sessions are stored in a data store, such as the historical data store 114. For example, for search queries that 109 are in the form of text, the text of the query is stored in the historical data store 114. For search queries 109 that are in the form of images, an index of the images is stored in the historical data store 114, or, optionally, the image is stored in the historical data store 114.

Selection data specifying actions taken in response to search results 111 provided in response to each search query 109 are also stored in the historical data store 114. These actions can include whether a search result 111 was selected, and for each selection, for which search query 109 the search result 111 was provided.

A set of search queries, such as search queries that have been received by the search system 120, are stored in a query index 116. In some implementations, the queries indexed in the query index 116 include a proper subset of the search queries 109 received by the search system 120. For example, the query index 116 may include search queries that have been received at least a threshold number of times and/or search queries that have at least a threshold level of performance, e.g., a click-through rate greater than a threshold.

### Detecting Content Selected by a Gesture

When a user is viewing content on the user device 106, the user can initiate a search for at least a portion of the content by making a gesture at or near the desired content. For example, if the user is viewing a web page that includes text describing something of interest, the user can circle the text by sweeping the text with a finger, stylus, or other pointer. In response to detecting a gesture, the user device 106 can submit a search request to the search system 120 for the selected content.

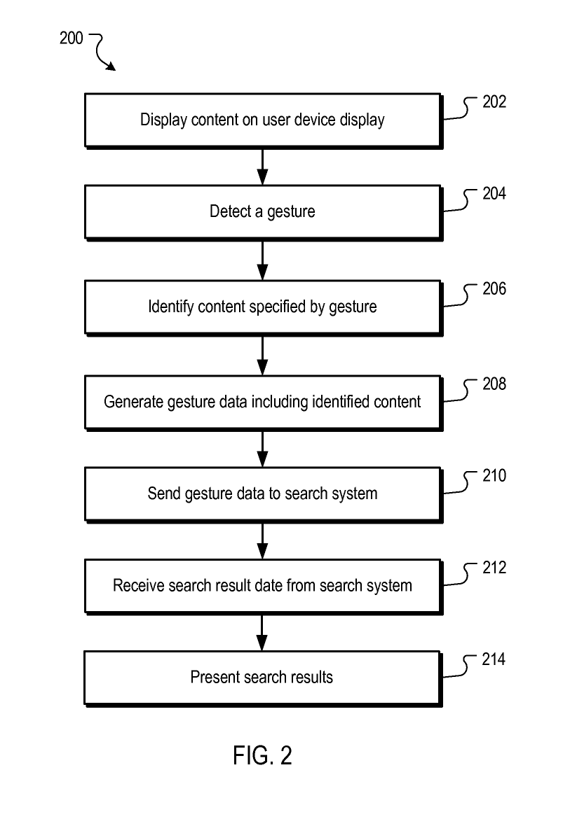

FIG. 2 is a flow chart of an example process 200 for submitting a search query 109 and presenting search results 111 responsive to the search query 109. The example process 200 can, for example, be implemented by the user device 106 of FIG. 1. Content is displayed on the display 107 of the user device 106. For example, a resource 105, such as a document or a web page having text, images, and/or video, may be displayed on the display 107.

Optionally, the user device 106 may be placed into a search mode, for example, in response to a user command. The user device 106 may receive a signal, such as a signal from activation of a button, an input from the touchscreen 108, a voice command from a microphone, or another suitable command. In some implementations, the user device 106 enters a search mode in response to the command such that certain gestures are interpreted to relate to the initiation of a search. For example, in the search mode, a selection gesture, e.g., a gesture that serves to select particular content currently being displayed, may be interpreted as a selection of content for search, whereas while not in the search mode, the same gesture on the touchscreen 108 may zoom, scroll, or reorient the content. In some implementations, the user device 106 may not require activation of a search mode to perform a gesture-triggered search.

A gesture is detected (204). In some implementations, the gesture includes a selection of content on the display. For example, a path may be traced by a gesture received by the touchscreen that encircles or otherwise substantially encloses a portion of content on the display. The user may trace the path using their finger, a stylus, or other pointer. In some implementations, the gesture includes a long-touch at a location on a touch screen of the user device 106. For example, if the touchscreen 108 detects a touch at a location for at least a threshold period of time, the user device 106 can interpret this as a long-touch gesture.

Content specified by the gesture is identified (206). For example, if the gesture encloses a portion of the displayed content, the user device 106 can identify the enclosed portion of content. If the gesture is a long touch, the user device 106 can detect the content on the display where the long touch was detected. The content specified by the gesture can include text, images, videos, and/or audio. For example, a user can encircle a portion of content that includes an image and text near the image.

In some implementations, the content specified by the gesture includes content proximal to the location of the gesture, such as text or images proximal to the location of the gesture. For example, the user device 106 may identify content within a certain distance from the gesture. For example, the user device 106 may identify content within a particular number of pixels, characters, or words from the gesture. If the gesture is a long touch near the beginning of a sentence, the user device 106 may identify the remainder of the sentence as content proximal to the gesture.

To illustrate, a web page may include the phrase “camp sites in the mountains near a lake.” If a user approximately touches the touchscreen 108 at the word “camp,” the user device 106 may identify the word “camp” as the content specified by the gesture and the phrase “sites in the mountains near a lake” as the content proximal to the gesture. This phrase can provide context for the selected term “camp” and can be used to generate candidate search queries as described in more detail below.

The user device 106 may identify text on either side of the selected text as content proximal to the gesture. For example, the user device 106 may include text before and after the selected text in a sentence or paragraph. The user device 106 may limit the additional text to a particular number of words. For example, the user device 106 may include three words prior to the selected text and three words after the selected text. Or, the user device 106 may detect that the selected text is within a sentence and include the entire sentence. By including this additional text, the context of the selected text may be used to generate candidate search queries.

In some implementation, the content includes an anchor point that specifies a center point of other point within the enclosed content and content within a particular distance from the anchor point. For example, the content may include the anchor point and any content that is displayed within a particular number of pixels from the anchor point.

Gesture data 110 is generated (208). The user device 106 can generate gesture data 110 that identifies the content specified by the gesture and the content identified as being proximal to the gesture. The gesture data 110 can include data distinguishing the content specified by the gesture and the content identified as being proximal to the gesture. This enables the data to be treated separately by the search system 120, or another system.

For text, the gesture data 110 can include the text as it is displayed on the display 107. For example, the gesture data 110 can maintain the order of words, sentences and paragraphs of text displayed on the display 107. For images, audio, and video, the gesture data 110 can include the content, data identifying the content, and/or meta information associated with the content. For example, images and videos often include meta information that includes data about the image or video.

The gesture data 110 is sent to the search system 120 (210). For example, the user device 106 can transmit the gesture data 110 to the search system 120 by way of the network 102. The gesture data 110 can be sent along with a request for search results 111 responsive to the content specified by the gesture. In some implementations, the user device 106 includes a query selector 123 that identifies one or more search queries based on the gesture data 110 and provides the one or more search queries to the search system 120.

Search results responsive to the content specified by the gesture are received (212). For example, the search system 120 can generate the search results based on the gesture data 110, or search queries received from the user device 106, and provide the identified search results to the user device 106. In turn, the user device 106 can present the search results on the display 107 (214).

### Search Result Processing

When gesture data 110 is received, the query selector 123 can identify one or more search queries for use in a search operation based on the content specified by the gesture data. The query selector 123 can identify a set of candidate search queries based on the content, score the candidate search queries, and provide one or more of the candidate search queries to the search engine 121. In response, the search engine 121 can identify resources 105 relevant to the search queries, generate search results 111 that reference the resources 105, and provide the search results 111 to the user device 106.

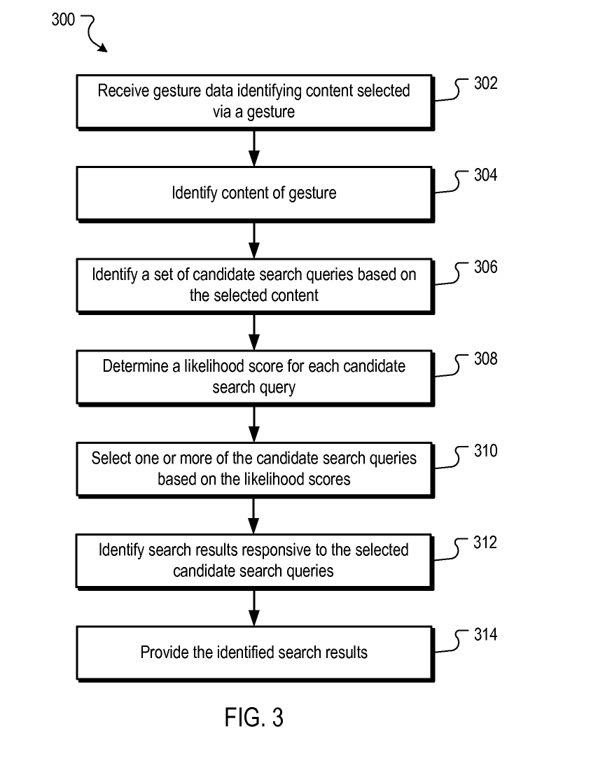

FIG. 3 is a flow chart of an example process 300 for providing search results 111 in response to a search query 109. The example process 300 can, for example, be implemented by the search system 120 of FIG. 1 or another data processing apparatus. In some implementations, the process 300, or a portion thereof, is implemented by a user device, such as the under device 106 of FIG. 1. For example, the query selector 123 may be a part of the user device 106.

Gesture data 110 identifying content specified by a gesture is received (302). For example, the search system 120 can receive the gesture data from a user device 106 at which the gesture data was generated.

The query selector 123 of the search system 120 identifies the content specified by the gesture and the content identified as being proximal to the specified content (304). For example, the query selector 123 can parse the gesture data 110 to identify this content.

A set of candidate search queries is identified based on the content specified by the gesture (306). The query selector 123 may identify search queries in the query index 116 that includes one or more terms of the gesture data 110. For example, if the gesture data 110 includes the previous example phrase, “flat camp sites in the mountains near a lake,” the search system 120 may identify, as candidate search queries, the terms “camp sites,” “mountain lakes,” “camp sites near a lake,” and “mountain camp sites.”

The query selector 123 can generate candidate search queries using a term selected by the gesture and one or more terms that were presented immediately before or after the selected term. Continuing the previous example, if the gesture data 110 specifies that the term selected is “camp,” the query selector 123 may generate candidate search queries of “flat camp,” “camp sites,” and “flat camp sites.”

In some implementations, the query selector 123 processes the content specified by the gesture prior to identify candidate search queries. For example, the query selector 123 may remove stop words, such as “and” and “the” from the content. The query selector 123 may also correct the spelling of words and/or replace words with synonyms.

The query selector 123 may perform similar processes on the candidate search queries prior to scoring. For example, the query selector 123 may remove stop words, correct spelling, and/or replace words with synonym prior to scoring.

In some implementations, the query selector 123 generates additional candidate search queries be generating query revisions for one or more of the candidate queries. For example, if the candidate search query is a stem for a common search query or is similar to a common search query, the search system 120 may include the search query as a candidate search query.

A likelihood score is determined for each candidate search query (308). In general, the likelihood score for a candidate search query is a measure of the likelihood that the candidate search query is the query intended by the user. The likelihood score for a particular candidate search query may be based on the frequency of occurrence of the candidate search query in a corpus of documents, the frequency of occurrence of the candidate search query in the resource or document from which the content specified by the gesture was selected, and/or the number of times the candidate search query has been received by the search system 120.

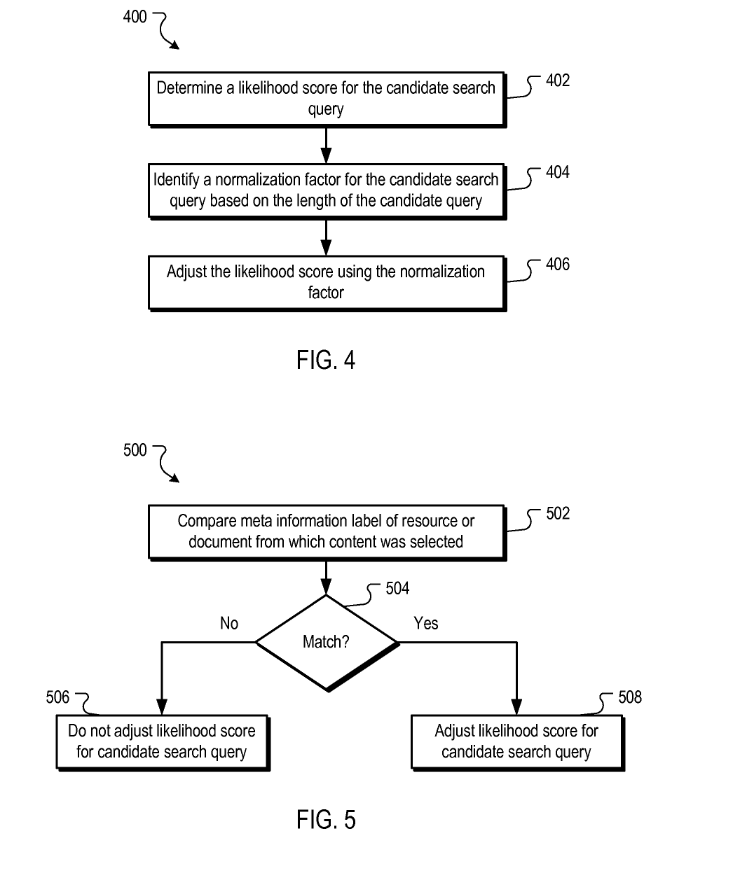

The likelihood scores can also be adjusted, for example, based on the lengths of the candidate search queries. As described above, users are more likely to enter a short query rather than a long query, although the long query may be more likely to surface search results that satisfy the user's informational needs. This is especially true for users entering queries on mobile devices, such as smartphones, as the user interface for entering search queries can be cumbersome. To account for this preference for entering shorter queries, the search system 120 can adjust the likelihood measures based on their lengths. Example processes for determining a likelihood score for a candidate search query are illustrated in FIGS. 4-6 and described below.

One or more of the candidate search queries are selected based on the likelihood scores (310). For example, the query selector 123 may select one or more of the candidate search results having the highest likelihood scores. The query selector 123 may select a particular number of the candidate search queries having the highest likelihood scores or each candidate search query that has a likelihood score that meets a threshold score.

Search results are identified for the selected candidate search queries (312). For example, the query selector 123 may send the selected candidate search queries to the search engine 121. In turn, the search engine 121 can identify, for each of the selected candidate search queries, a set of resources 105 that are responsive to the candidate search query. From the set(s) of resources 105, the search engine 121 can select one or more of the resources 105 and generate search results 111 that reference the selected resources.

As described above, the query selector 123 may be a part of the search system 120, the user device 106, or a third party system. For implementations in which the query selector 123 is part of a user device 106, the user device 106 may send the selected candidate queries to the search system 120, for example with a search request. The search request may also include the gesture data 110. For third party systems, the user device 106 may send the gesture data 110 to the third party system. In turn, the third party system may select candidate search queries based on the gesture data and provide the candidate search queries to the search engine 121.

The search results 111 are provided (314). For example, the search engine 121 can provide the search results 111 to the user device 106. In turn, the user device 106 can present the search results 111 to the user.

In some implementations, the search system 120 provides candidate search queries to the user device 106 instead of, or in addition to, search results 111. For example, the search system 120 may provide the candidate search queries as proposed queries that the user can select from. If a candidate search query is selected, the search system 120 can provide search results 111 for the selected candidate search query. For example, the user device 106 may provide the selected candidate search query to the search engine 121. The search engine 121 can identify resources responsive to the one or more search queries, generate search results 111 that identify the resources, and provide the search results 111 to the user device.

### Scoring Candidate Search Queries

As described above, the query selector 123 identifies and scores candidate search queries for content selected by way of a gesture. As the content may not be the actual query intended by the user, the query selector 123 selects one or more candidate search queries that are likely to be what the user intended. The candidate search queries can be scored based on their respective likelihoods and/or other factors, such as their respective lengths.

FIG. 4 is a flow chart of an example process 400 for determining likelihood score for candidate search queries. The example process 400 can, for example, be implemented by the query selector 123 of FIG. 1. An initial likelihood score is determined for each candidate search query (402). The initial likelihood score for a candidate search query can be a measure of the likelihood that the candidate search query is the query intended by the user.

There are a number of appropriate ways an initial likelihood score can be determined. In some implementations, the initial likelihood score for a candidate search query is a probability of occurrence for the candidate search query in a query corpus, which can be based on a historical frequency of occurrence for the candidate search query. For example, the initial likelihood score may be based on the number of times a search query 109 that matches the candidate search query has been received by the search system 120. This number may be limited to a particular time period. For example, the initial likelihood score may be based on the number of times the matching search query has been received during the past month. The initial likelihood score may be proportional to a ratio between the number of times the matching search query has been received and a time period over which the matching search queries were received.

In some implementations, the initial likelihood score for a candidate search query is based on the number of times the candidate search query appears in the resource or document displaying the content. For example, the query selector 123 may receive the text for the resource and document and determine the number of times the candidate search query occurs in the resource or document.

In some implementations, the initial likelihood score for a candidate search query is based on the number of times the candidate search query appears in a corpus of documents. For example, the initial likelihood score may be based on the number of times the candidate search query appears in documents indexed in the search index 112. The initial likelihood score for a candidate search query can be based on a combination of the number of times the candidate search query has been received, the number of times the candidate search query occurs in the resource or document, and/or the number of times the candidate search query appears in the corpus of documents.

For candidate search queries that have multiple terms, the initial likelihood score for a candidate search query may be based on a score for each individual term. For example, the query selector 123 may identify a likelihood score for each individual term and combine these scores to determine the likelihood score for the candidate search query. The individual scores can be averaged to determine the likelihood score for the candidate search query.

A normalization factor is identified for each candidate search query (404). The normalization factor is a factor by which the initial likelihood score is adjusted. In some implementations, the normalization factor for a candidate search query is based on the length of the candidate search query. As described above, users are more likely to enter a short query rather than a long query, although the long query may be more likely to surface search results that satisfy the user's informational needs. To account for this preference for entering shorter queries, the query selector 123 can adjust the initial likelihood measure for each candidate search query using a respective normalization factor that is based on the search query's length.

In some implementations, the normalization factor for a candidate search query is based on the length of the candidate search query measured by the number of characters of the search query and/or the number of individual words in the candidate search query. For example, a candidate search query having a larger number of characters may have a smaller normalization factor than a search query having a smaller number of characters. Similarly, a candidate search query having a larger number of words may have a smaller normalization factor than a search query having a smaller number of words. In these examples, initial likelihood scores are divided by the normalization factors such that the longer candidate search queries will receive a boost to their likelihood scores when the likelihood scores are divided by their normalization factors.

The normalization factor for a candidate search query may be determined based on the frequency of occurrence for search queries having the same length, or a similar length, as the candidate search query. For example, if a candidate search query has a number of words “n” and a number of characters “x”, the query selector 123 may identify the frequency of occurrence or likelihood of receiving a search query having “n” words and “x” characters using the historical data 114. The query selector can use this frequency or likelihood to determine the normalization factor for the candidate search query. In some implementations, the query selector 123 determines the normalization factors for candidate search queries of various lengths and stores these normalization factors in the query index 116 or another data store for retrieval at query time.

For multiple term candidate search queries, the normalization factor may be based on a frequency of occurrence for each term of the candidate search query. For example, the normalization factor for a multi-term candidate search query may the product of the frequency of occurrence for each term.

The initial likelihood scores are adjusted using their respective normalization factors to generate adjusted likelihood scores (406). For example, the query selector 123 may divide the initial likelihood scores by their respective normalization factors in implementations where longer candidate search queries have smaller normalization factors than shorter queries. In another example, the query selector may multiply the initial likelihood scores by the normalization factors in implementations where shorter queries have smaller normalization factors than longer queries.

The query selector 123 can also be configured to boost the likelihood score for candidate search queries if the candidate search queries have a particular attribute. For example, the query selector 123 may boost the likelihood score for a candidate search query that has one or more terms that match a one or more terms of a meta information label of a document or resource from which content was selected by way of a gesture. In another example, the query selector 123 may boost the likelihood score for a candidate search query that has a particular semantic meaning or that matches a particular domain, such as an address or a phone number.

FIG. 5 is a flow chart of an example process 500 for selectively adjusting a likelihood score for a candidate search query. The example process 500 can, for example, be implemented by the query selector 123 of FIG. 1. A meta information label for a resource or document from which content was selected via a gesture is compared to a candidate search query (502). For example, some resources include a meta information tag or label with data regarding the resource. The query selector can compare the meta information label to one or more terms of the candidate search query to determine whether there is a match (504).

If there is not a match between the meta information label and the candidate search query, the query selector 123 may leave a likelihood score for the candidate search query unchanged (506). If there is a match between the meta information label and the candidate search query, the query selector 123 may adjust the likelihood score for the candidate search query (508). For example, the query selector 123 may increase the likelihood score for the candidate search query. A match between the meta information label and the candidate search query may indicate that the candidate search query is relevant to the resource or document.

In some implementations, the process 500 is performed for meta information labels for images or videos included on the resource. For example, if one or more terms of the candidate search query match a meta information label for an image presented on the resource, the query selector 123 may increase the likelihood score for the candidate search query.

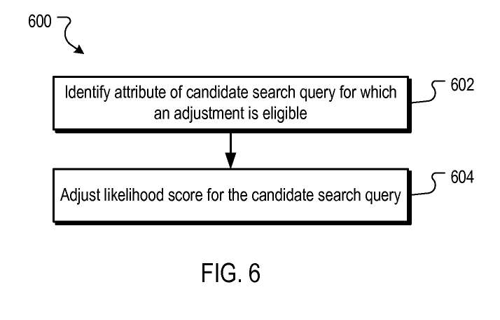

FIG. 6 is a flow chart of an example process 600 for adjusting a likelihood score for a candidate search query. The example process 600 can, for example, be implemented by the query selector 123 of FIG. 1. An attribute of a candidate search query that is eligible for adjustment to its likelihood score is identified (602). Particular attributes may be eligible for an adjusted likelihood score. For example, candidate search queries that have a particular semantic meaning or that match a particular domain may be eligible for an increase to its likelihood score. Some example semantic meanings or domains include an address, a phone number, a person's name, a full product name, the name of a book or movie, and less common search terms.

Search queries that are commonly submitted to the search system 120 after the resource or document is presented may also be eligible for an increased likelihood score. For example, if users commonly submit a query for “tents” after viewing a web page about camp sites, then the likelihood score for candidate search queries that include the term “tents” may be increased.

Candidate search queries that have previously been received by the search system 120 may also be eligible for adjustment. For example, if a particular user has submitted a particular candidate search query at least a threshold number of times, the particular candidate search query may be eligible for adjustment.

In response to identifying the attribute, the query selector 123 adjusts the likelihood score for the candidate search query (604). For example, each attribute may have a corresponding adjustment amount that the query selector 123 applies to the likelihood score for the candidate search query. These adjustment amounts may increase the likelihood scores for the candidate search query.

### Additional Implementation Details

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media, e.g., multiple CDs, disks, or other storage devices.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program, also known as a program, software, software application, script, or code, can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network, e.g., the Internet, and peer-to-peer networks, e.g., ad hoc peer-to-peer networks.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a client device, e.g., for purposes of displaying data to and receiving user input from a user interacting with the client device. Data generated at the client device, e.g., a result of the user interaction, can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
receiving gesture data specifying a user gesture interacting with a portion of displayed content;
identifying a subset of the content based on the gesture data;
identifying a set of candidate search queries based at least on the subset of the content;
for each candidate search query:
determining a likelihood score for the candidate search query, the likelihood score for the candidate search query indicating a likelihood that the candidate search query is an intended search query specified by the user gesture; and
adjusting the likelihood score for the candidate search query using a normalization factor, the normalization factor being based on a number of characters included in the candidate search query; and
selecting one or more of the candidate search queries based on the adjusted likelihood scores.

2. The method of claim 1, further comprising:
identifying search results responsive to the one or more selected candidate search queries; and
providing the identified search results.

3. The method of claim 1, wherein the likelihood score for the candidate search query is based on a number of occurrences of the candidate search query in one or more documents.

4. The method of claim 1, wherein the likelihood score for the candidate search query is based on a number of occurrences of the candidate search query in a set of received search queries.

5. The method of claim 1, wherein the normalization factor is based on a number of search queries in a set of received search queries that include the number of characters included in the candidate search query.

6. The method of claim 5, wherein the normalization factor is further based on a number of words included in the candidate search query.

7. The method of claim 1, wherein the normalization factor is further based on a number of words included in the candidate search query.

8. The method of claim 1, wherein adjusting the likelihood score for the candidate search query using a normalization factor comprises determining a ratio between the likelihood score for the candidate search query and the normalization factor for the candidate search query.

9. The method of claim 1, further comprising:
identifying a semantic signal for a particular candidate search query, the sematic signal indicating that the particular candidate search query has a particular semantic meaning;
and improving the adjusted likelihood score in response to identifying the semantic signal.

10. The method of claim 1, further comprising:
determining that a particular candidate search query matches a meta information label associated with a document containing the displayed content; and
in response to determining that the particular candidate search query matches a meta information label associated with a document containing the displayed content, further adjusting the adjusted likelihood score for the particular candidate search query.

11. The method of claim 1, wherein:
a particular candidate search query has a number of words (“n”) and a number of characters (“x”); and
adjusting the likelihood score for the particular candidate search query using a normalization factor, the normalization factor being based on a number of characters included in the particular candidate search query comprises:
identifying a likelihood of receiving a search query that has “n” words and “x” characters as the normalization factor for the particular candidate search query; and
dividing the likelihood score for the particular candidate search query by the normalization factor for the particular search query to determine the adjusted likelihood score for the particular candidate search query.

12. A system, comprising:
a processing apparatus;
a memory storage apparatus in data communication with the data processing apparatus, the memory storage apparatus storing instructions executable by the data processing apparatus and that upon such execution cause the data processing apparatus to perform operations comprising:
receiving gesture data specifying a user gesture interacting with a portion of displayed content;
identifying a subset of the content based on the gesture data;
identifying a set of candidate search queries based at least on the subset of the content;
for each candidate search query:
determining a likelihood score for the candidate search query, the likelihood score for the candidate search query indicating a likelihood that the candidate search query is an intended search query specified by the user gesture; and
adjusting the likelihood score for the candidate search query using a normalization factor, the normalization factor being based on a number of characters included in the candidate search query; and
selecting one or more of the candidate search queries based on the adjusted likelihood scores.

13. The system of claim 12, wherein the instructions upon execution cause the data processing apparatus to perform further operations comprising:
identifying search results responsive to the one or more selected candidate search queries; and
providing the identified search results.

14. The system of claim 12, wherein the likelihood score for the candidate search query is based on a number of occurrences of the candidate search query in a set of received search queries.

15. The system of claim 12, wherein the normalization factor is based on a number of search queries in a set of received search queries that include the number of characters included in the candidate search query.

16. The system of claim 12, wherein the normalization factor is further based on a number of words included in the candidate search query.

17. The system of claim 12, wherein:
a particular candidate search query has a number of words (“n”) and a number of characters (“x”); and
adjusting the likelihood score for the particular candidate search query using a normalization factor, the normalization factor being based on a number of characters included in the particular candidate search query comprises:
identifying a likelihood of receiving a search query that has “n” words and “x” characters as the normalization factor for the particular candidate search query; and
dividing the likelihood score for the particular candidate search query by the normalization factor for the particular search query to determine the adjusted likelihood score for the particular candidate search query.

18. A computer storage medium encoded with a computer program, the program comprising instructions that when executed by a data processing apparatus cause the data processing apparatus to perform operations comprising:
receiving gesture data specifying a user gesture interacting with a portion of displayed content;
identifying a subset of the content based on the gesture data;
identifying a set of candidate search queries based at least on the subset of the content;
for each candidate search query:
determining a likelihood score for the candidate search query, the likelihood score for the candidate search query indicating a likelihood that the candidate search query is an intended search query specified by the user gesture; and
adjusting the likelihood score for the candidate search query using a normalization factor, the normalization factor being based on a number of characters included in the candidate search query; and
selecting one or more of the candidate search queries based on the adjusted likelihood scores.

19. The computer storage medium of claim 18, wherein the instructions upon execution cause the data processing apparatus to perform further operations comprising:
identifying search results responsive to the one or more selected candidate search queries; and
providing the identified search results.

20. The computer storage medium of claim 18, wherein the normalization factor is based on a number of search queries in a set of received search queries that include the number of characters included in the candidate search query.

21. The computer storage medium of claim 18, wherein the normalization factor is further based on a number of words included in the candidate search query.

22. The computer storage medium of claim 18, wherein:
a particular candidate search query has a number of words (“n”) and a number of characters (“x”); and
adjusting the likelihood score for the particular candidate search query using a normalization factor, the normalization factor being based on a number of characters included in the particular candidate search query comprises:
identifying a likelihood of receiving a search query that has “n” words and “x” characters as the normalization factor for the particular candidate search query; and
dividing the likelihood score for the particular candidate search query by the normalization factor for the particular search query to determine the adjusted likelihood score for the particular candidate search query.
